(19) United States
(12) Patent Application Publication
(10) Pub. No.: US 2022/0374031 A1
(43) Pub. Date: Nov. 24, 2022

(54) METHOD FOR HEAT MANAGEMENT, IN PARTICULAR FOR A MOTOR VEHICLE, AND ASSOCIATED HEAT MANAGEMENT STRATEGY AND CONTROL UNIT

(71) Applicant: Valeo Systemes Thermiques, Le Mesnil Saint-Denis (FR)

(72) Inventors: Bertrand Puzenat, Le Mesnil Saint-Denis (FR); Erwan Gogmos, Le Mesnil Saint-Denis (FR)

(73) Assignee: Valeo Systemes Thermiques, Le Mesnil Saint-Denis (FR)

(21) Appl. No.: 17/764,743

(22) PCT Filed: Sep. 23, 2020
(86) PCT No.: PCT/FR2020/051659

§ 371 Date: Mar. 29, 2022

(30) Foreign Application Priority Data
Oct. 1, 2019 (FR) FR1910893

(51) Int. Cl. G05D 23/19; H05B 1/02; B60H 1/22

(52) U.S. Cl. CPC G05D 23/1917; H05B 1/0236; B60H 1/2218; B60H 2001/00128

(57) ABSTRACT

The invention concerns a heat management method for an electric heating device comprising at least one subassembly of resistive elements configured to be electrically supplied and a support for a circuit supplying power to the resistive elements, wherein the power supply of the resistive elements is controlled according to a power setpoint (P_(sub)system_target_0) or temperature (T_(sub)system_target_0) or electrical current amplitude (i_(sub)system_target_0) or resistance (R_(sub)system_target_0), or even a duty ratio of the control signal (PWM_(sub)system_target_0). According to the invention, the method comprises the following steps: recording the temperature (T_PCB) of the support of the circuit supplying power to the resistive elements, comparing the recorded temperature (T_PCB) with at least one predefined temperature threshold (T1), and if the recorded temperature (T_PCB) is greater than or equal to the at least one predefined temperature threshold (T1), generating a command to reduce the setpoint by a predetermined step. The invention also concerns a corresponding heat management strategy and control unit.

The invention relates to a thermal management method for an electrical heating device for heating a fluid. It is in particular a question of an electrical heating device with which a motor vehicle is intended to be equipped. Nonlimitingly, the electrical heating device may be configured to heat, for example, an air flow intended to flow through the heating device. The invention may be applied equally well to a high-voltage electrical heating device as to a low-voltage electrical heating device. The invention also relates to a thermal management strategy applied during operation of the electrical heating device. The invention also relates to a control unit for implementing at least part of the thermal management method and/or of the thermal management strategy.

The invention especially applies to a motor-vehicle heating and/or ventilation and/or air-conditioning apparatus comprising such a heating device.

A motor vehicle is commonly equipped with such a heating and/or ventilation and/or air-conditioning apparatus, which is intended to regulate aerothermal parameters of an air flow intended to be delivered to the passenger compartment, and in particular the temperature of the air flow. To do this, the apparatus generally comprises one or more heat-treatment devices, and especially an electrical heating device (also called an electrical radiator) for heating a fluid such as an air flow.

The electrical heating device comprises electrical heating modules. By way of example, the electrical heating modules may be arranged so as to be directly exposed to an air flow flowing through the electrical heating device.

According to one known solution, the heating modules comprise resistive elements, for example PTC resistive elements (PTC being the acronym of positive temperature coefficient) such as PTC ceramics, which are also referred to as PTC ceramic resistors.

It is a question of elements the resistance of which varies greatly as a function of temperature. More precisely, the ohmic value of PTC resistive elements increases very rapidly beyond a predetermined temperature threshold.

The resistive elements may be supplied by an on-board electrical voltage source, namely batteries. An electrical connector may be connected to the voltage source located on-board the vehicle, so as to allow the required electrical power to be supplied to the electrical heating device, and especially to the resistive elements. Furthermore, the resistive elements are controlled by an electronic control unit that generally comprises an electrical supply circuit. The electrical supply circuit is for example mounted on a printed circuit board.

In particular in the case of a high-voltage electrical heating device, it may be a question of a main heating device of the vehicle, and which may therefore be very powerful.

In case of overheating, the device may reach at at least one point a temperature limit of correct operation of the system. PTC resistive elements are used to protect against excessive overheating that could, for example, start a fire, thus allowing the safety of passengers to be guaranteed.

However, certain components close to the electrical heating device, such as for example plastic parts of the heating and/or ventilation and/or air-conditioning apparatus, may be more sensitive especially under certain conditions, for example in the case of a high temperature when the shutters of the heating and/or ventilation and/or air-conditioning apparatus are closed, intentionally or due to an undetected mechanical failure.

It is therefore advantageous to control the temperature of the electrical heating device, in order to avoid degrading surrounding components.

The objective of the invention is to provide a thermal management solution allowing the aforementioned drawbacks of the prior art to be at least partially avoided.

To this end, one subject of the invention is a thermal management method for an electrical heating device comprising at least one subset of resistive elements configured to be supplied electrically and a carrier of an electrical supply circuit of the resistive elements, wherein the electrical supply of the resistive elements is controlled depending on a power setpoint or a temperature setpoint or an electrical current setpoint or a resistance setpoint, or even depending on a setpoint of the duty cycle of the control signal.

According to the invention, said method comprises the following steps: noting the temperature of the carrier of the electrical supply circuit of the resistive elements, comparing the noted temperature with at least one predefined temperature threshold, and if the noted temperature is higher than or equal to said at least one predefined temperature threshold, generating a command to lower said setpoint by a predetermined increment.

Said method may also comprise one or more of the following features, implemented separately or in combination:

According to one embodiment, a predetermined number of temperature thresholds is defined, the temperature thresholds being of rank n and varying from one to a predefined maximum number m.

Said method may comprise the following steps: the noted temperature of said carrier is compared with the temperature thresholds of rank n, and if the noted temperature is higher than or equal to the temperature threshold of given rank n and lower than the temperature threshold of higher rank n+1, for n varying from one to m−1, the higher the rank n of the temperature threshold the more the lowering of said setpoint is accentuated.

According to one aspect of the invention, after a temperature threshold of rank n has been passed beyond, and following an associated command to lower, said method comprises the following steps: noting and again comparing the temperature of said carrier with the temperature threshold of rank n and with a temperature threshold of higher rank n+1; if and as long as the noted temperature is higher than or equal to the temperature threshold of rank n and lower than the temperature threshold of higher rank n+1, maintaining said lowered setpoint as set by the preceding command to lower; if the noted temperature is lower than the temperature threshold of rank n, returning to the preceding command to lower said setpoint; and if the noted temperature is higher than or equal to the temperature threshold of higher rank n+1, generating a command to lower said setpoint more so as to accentuate the lowering.

According to one aspect, said setpoint is lowered in constant predetermined increments. The increments may be between 5% and 30%, and for example of 20%, of said setpoint or of the maximum permitted setpoint value.

Alternatively, said setpoint is lowered in predetermined increments that differ depending on the temperature thresholds.

A maximum temperature threshold higher than said at least one temperature threshold may be defined, said method comprising a step of comparing the noted temperature with the maximum temperature threshold, and, if the maximum temperature threshold has been reached, said method comprises a step of generating a command to stop the electrical supply of said at least one subset of resistive elements.

After the electrical supply of said at least one subset of resistive elements has been stopped, said method may comprise at least one step of verifying a condition permitting resumption of the electrical supply.

A first verifying step may comprise the following sub-steps: after the electrical supply has been stopped, noting the temperature of said carrier with the maximum temperature threshold, and verifying whether the noted temperature of said carrier is lower than the maximum temperature threshold.

Said method may comprise an additional verifying step comprising the following sub-steps: noting the temperature of the carrier of the electrical supply circuit of the resistive elements and comparing it with a predefined resumption temperature threshold, and if the noted temperature is lower than the predefined resumption temperature threshold, generating a command to resume the electrical supply of said at least one subset of resistive elements.

The predefined resumption threshold is for example lower than or equal to said at least one threshold and/or lower than the maximum threshold. The resumption threshold is for example equal to said at least one threshold or alternatively to said at least one threshold from which a certain temperature, 10° C. for example, has been subtracted, or alternatively equal to the maximum threshold from which a certain temperature, 10° for example, has been subtracted.

The supply may restart with a limited setpoint or at the maximum permitted setpoint value.

The invention also relates to a thermal management strategy for an electrical heating device comprising at least one subset of resistive elements configured to be supplied electrically and a carrier of an electrical supply circuit of the resistive elements, wherein the electrical supply of the resistive elements is controlled using a pulse-width modulated control signal depending on a power setpoint, or a temperature setpoint, or an electrical current setpoint, or a resistance setpoint, or even a setpoint of the duty cycle of the control signal.

The thermal management strategy comprises one or more of the following control phases.

A first phase is one of verifying whether at least one operating parameter of the electrical heating device meets a condition to limit the setpoint requested by a user of said device to a maximum allowable setpoint determined depending on said at least one operating parameter.

A second phase is one of monitoring the temperature of the carrier of the electrical supply circuit of the resistive elements and of regulating the requested setpoint or the maximum allowable setpoint depending on the temperature of said carrier, such as defined above.

When the setpoint is an electrical power setpoint or temperature setpoint or electrical current setpoint or resistance setpoint, a third phase may be one of gradually limiting in predefined increments, if and as long as the duty cycle of the control signal is beyond a corresponding detection threshold value, or at least one parameter for monitoring overheating has reached a corresponding detection threshold value, said setpoint being increased otherwise.

When the setpoint is a setpoint of the duty cycle of the control signal, a third phase may be one of gradually limiting in predefined increments, if and as long as at least one parameter for monitoring overheating is beyond a corresponding detection threshold value, said setpoint being increased otherwise.

A fourth phase is one of monitoring the electrical resistance of said at least one subset of resistive elements, and of generating a command to stop the electrical supply of the resistive elements for a predetermined time, if the electrical resistance has reached or passed beyond a predefined threshold value.

A fifth phase is one of monitoring the temperature of the carrier of the electrical supply circuit of the resistive elements and of generating a command to stop the electrical supply of the resistive elements for a predetermined time if the temperature of said carrier reaches a maximum temperature threshold.

The predetermined stoppage time in the fourth or the fifth phase is for example of the order of 130 s.

Regarding the fifth phase, the maximum temperature threshold is higher than the temperature thresholds of the second phase.

The conditions of application of the control phases are advantageously verified successively from the first to the fifth phase in that order.

After the 130 s of stoppage, the setpoint may be set to 100% or alternatively it may be limited for example to 55%.

The invention also relates to a control unit for an electrical heating device comprising at least one subset of resistive elements configured to be supplied electrically and a carrier of an electrical supply circuit of the resistive elements, the control unit being configured to generate a control signal depending on a power setpoint, or a temperature setpoint, or an electrical current setpoint, or a resistance setpoint, or even a setpoint of the duty cycle of the control signal.

The control unit comprises at least one processing means for: noting the temperature of the carrier of the electrical supply circuit of the resistive elements, comparing the noted temperature with at least one predefined temperature threshold, and if the noted temperature is higher than or equal to said at least one predefined temperature threshold, generating a command to lower said setpoint by a predetermined increment.

The control unit may comprise at least one temperature sensor such as a probe of negative temperature coefficient (NTC), for noting the temperature of the carrier of the electrical supply circuit of the resistive elements. The temperature sensor may be mounted on said carrier.

Alternatively, the temperature sensor may be mounted “in proximity to” said carrier, for example at a distance of 5 mm to 50 mm.

The control unit may comprise a comparator for comparing the noted temperature with a predefined first temperature threshold.

The control unit may comprise a computer or microprocessor configured to regulate said setpoint and/or to generate a command to stop the supply of the resistive elements and/or to generate a command to resume the electrical supply following a stoppage.

The control unit generates a pulse-width modulated control signal for controlling the electrical supply of the resistive elements.

The resistive elements may be of positive temperature coefficient.

According to one variant embodiment, the resistive elements are of negative temperature coefficient.

The control unit may comprise one or more processing means for implementing, at least in part, at least one control phase of the thermal management strategy such as defined above.

Other features and advantages of the invention will become more clearly apparent on reading the following description, which is given by way of illustrative and nonlimiting example, and the appended drawings, in which:

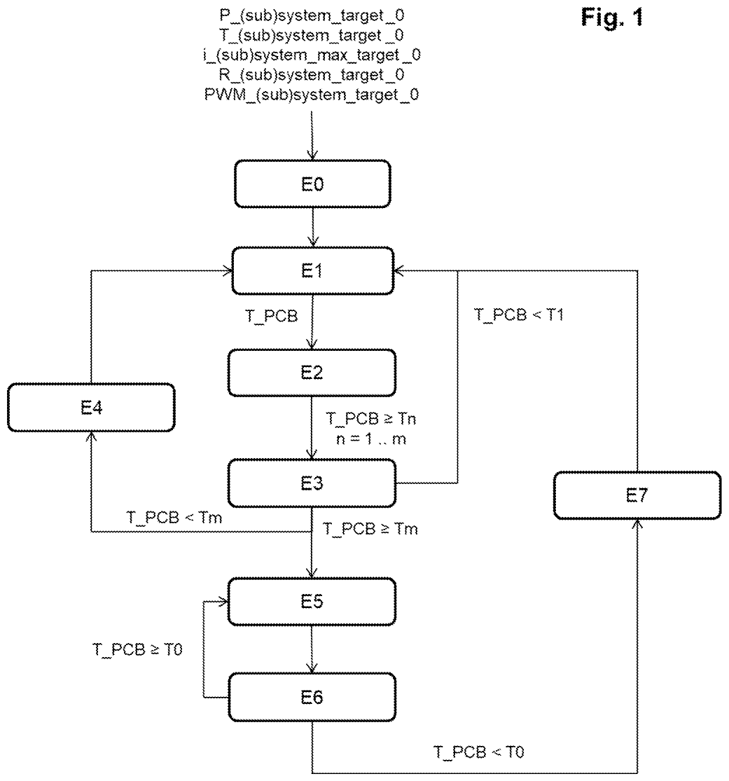

FIG. 1 shows a flowchart of various steps of a thermal management method according to the invention.

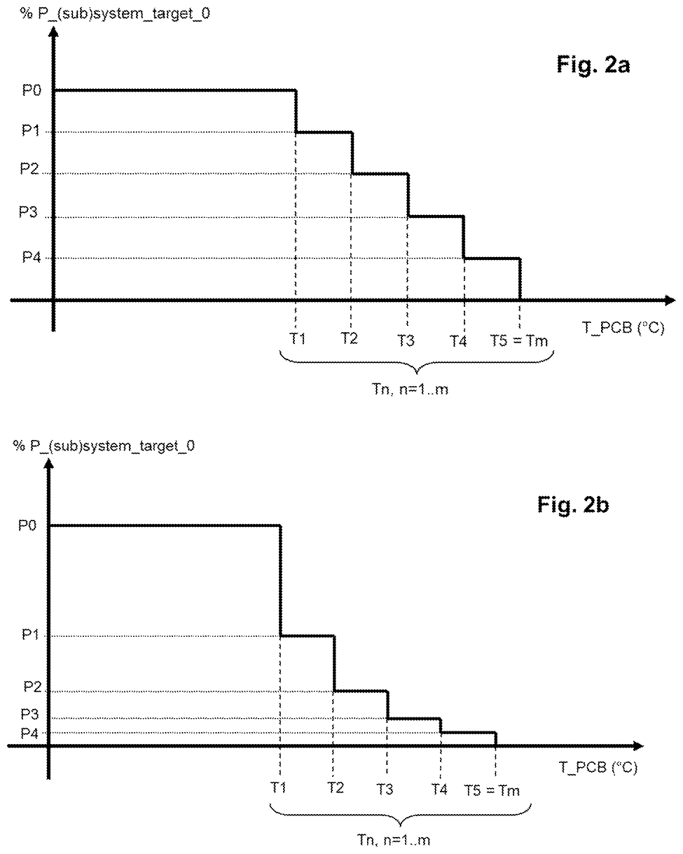

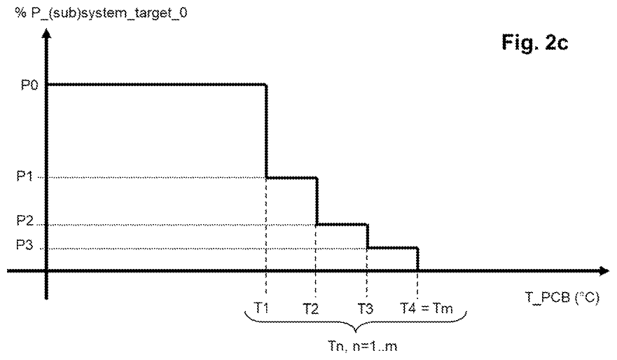

FIG. 2a is a graph of the variation in an electrical power setpoint as a function of temperature thresholds reached by a carrier of an electrical supply circuit, according to a first example.

FIG. 2b is a graph of the variation in an electrical power setpoint as a function of temperature thresholds reached by a carrier of an electrical supply circuit, according to a second example.

FIG. 2c is a graph of the variation in an electrical power setpoint as a function of temperature thresholds reached by a carrier of an electrical supply circuit, according to a third example.

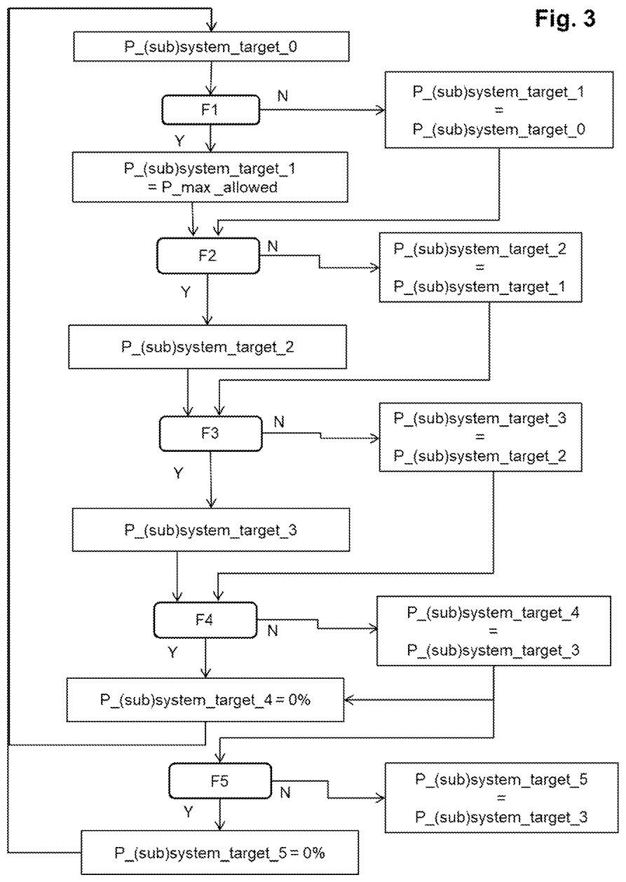

FIG. 3 shows a flowchart of various control phases according to one thermal management strategy.

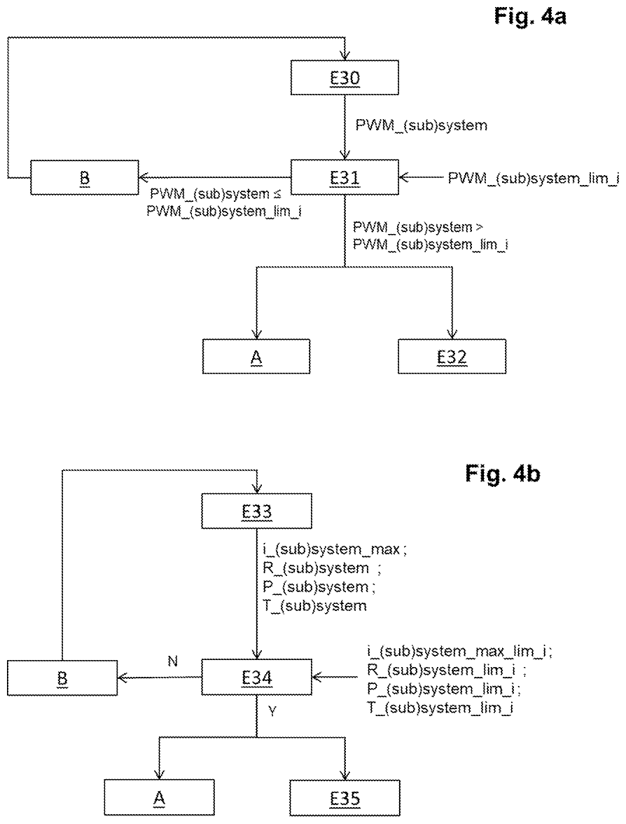

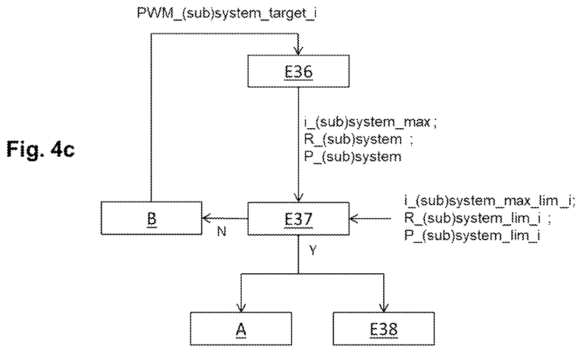

FIG. 4a shows a flowchart of various steps of a thermal management method, according to a first example of a control phase of the thermal management strategy of FIG. 3.

FIG. 4b shows a flowchart of various steps of a thermal management method, according to a second example of a control phase of the thermal management strategy of FIG. 3.

FIG. 4c shows a flowchart of various steps of a thermal management method, according to a third example of a control phase of the thermal management strategy of FIG. 3.

In these figures, identical elements have been designated by the same references.

The following embodiments are examples. Although the description refers to one or more embodiments, this does not necessarily mean that each reference relates to the same embodiment, or that the features apply only to a single embodiment. Individual features of various embodiments may also be combined or interchanged in order to create other embodiments.

The invention relates to the field of a heating and/or ventilation and/or air-conditioning apparatus (not shown in the figures) employing an air flow, with which apparatus a motor vehicle is intended to be equipped with a view to regulating the aerothermal parameters of the air flow, which is delivered to one or more regions of the passenger compartment of the vehicle.

The invention more particularly relates to a motor-vehicle electrical heating device (also called an electrical radiator) with which such an apparatus is especially equipped. It is a question of an electrical device for heating a fluid. Nonlimitingly, it may be a question of a device for heating an air flow. Below, the description is given with reference to an air flow, but the invention may be applied to another fluid.

In particular, it may be a question of a high-voltage radiator or electrical heating device. The expressions “high voltage” and “high-voltage” define, for example, a voltage higher than 90 V or 120 V. As a variant, it may be a question of a low-voltage radiator.

The electrical heating device is configured to convert electrical energy drawn for example from the vehicle into thermal energy that is transferred to an air flow flowing through the heating and/or ventilation and/or air conditioning apparatus.

The electrical heating device may comprise a predefined number of heating modules. These heating modules may be arranged so as to be directly exposed to the air flow flowing through the electrical heating device.

More precisely, the heating modules may each comprise resistive elements. The electrical heating device therefore comprises a plurality of resistive elements configured to be supplied electrically by an electrical voltage source.

The resistive elements may be resistive elements of positive temperature coefficient (PTC). The resistive elements for example take the form of PTC ceramics, and for example of the PTC ceramics known as PTC ceramic resistors. As a variant, it may be a question of resistive elements of negative temperature coefficient (NTC).

The electrical heating device generally furthermore comprises an electronic control unit for controlling the heating modules. Such a control unit comprises one or more electronic and/or electrical components. The control unit especially comprises an electrical circuit (not shown) for supplying the resistive elements. The electrical supply circuit is for example mounted on an electrical circuit carrier such as a printed circuit board (or PCB to use the well-known acronym).

By way of example, the electrical supply circuit comprises transistors (not shown), each allowing the passage of current through a predefined number of heating modules to be permitted or not.

The resistive elements are intended to be supplied by an electrical power source (not shown), such as batteries, of the vehicle for example. The electrical supply of the resistive elements is controlled by pulse-width modulation (or PWM to use the well-known acronym).

The control unit is configured to generate a pulse-width-modulated control signal for controlling the electrical supply of the resistive elements, and in particular of at least a subset of resistive elements. Distinct subsets of resistive elements may be independently controlled by pulse width modulation. The resistive elements, and in particular at least one subset of resistive elements forming a subsystem, may be supplied electrically depending on a setpoint.

According to one preferred embodiment, the setpoint is an electrical power setpoint_P_(sub)system_target_0 (FIG. 1). The heating device is controlled in a closed-loop mode. As a variant, the resistive elements may be supplied electrically depending on a temperature setpoint T_(sub)system_target_0. It is possible to envisage an alternative with a constant-voltage electrical current setpoint i_(sub)system_target_0, or optionally a resistance setpoint R_(sub)system_target_0.

Alternatively, the method may be controlled in an open-loop mode. The resistive elements, and in particular at least one subset of resistive elements forming a subsystem, may be supplied electrically depending on a pulse-width-modulation setpoint, which is designated the PWM setpoint below. The “sub” prefix has been written between parentheses to indicate that the setpoint regards either a subset of resistive elements or all of the resistive elements.

The “sub” prefix has been written between parentheses to indicate that the setpoint regards either a subset of resistive elements or all of the resistive elements.

Thermal Management Method

FIG. 1 schematically represents the steps of a thermal management method for detecting overheating of the electrical heating device and acting to prevent the electrical heating device from reaching a critical temperature.

At the start of the method, the resistive elements are controlled depending on an initial setpoint that corresponds to the minimum between the setpoint received from the control unit controlling the resistive elements and a maximum permitted setpoint. By way of illustration, for a power setpoint, the initial power setpoint_P_(sub)system_target_0 or maximum permitted power setpoint is for example equal to 80% of a maximum power.

Generally, the thermal management requires the temperature T_PCB of the carrier of the electrical supply circuit to be monitored.

The thermal management method comprises a preliminary step E1 of noting the temperature T_PCB of the carrier of the electrical supply circuit of the resistive elements. The temperature T_PCB of the carrier is noted, for example by a temperature sensor, such as a thermal probe of negative temperature coefficient.

The noted temperature T_PCB of the carrier may be compared, in a step E2, with at least one predefined temperature threshold Tn, for example at least one first threshold T1.

In particular, with reference also to FIGS. 2a to 2c, a predetermined number of temperature thresholds Tn is defined. The rank n of the temperature thresholds Tn varies from one to a predefined maximum number m. By way of non-limiting example, four or five temperature thresholds may be defined. The maximum threshold Tm may be comprised between 115° C. and 130° C., and for example of about 120° C.

If the noted temperature T_PCB of the carrier is lower than the first threshold T1, the method may be reiterated, in particular the measuring and comparing steps E1 to E2 may be reiterated.

If the noted temperature T_PCB of the carrier reaches or passes beyond the temperature threshold T1 with which it is compared, the method may comprise a step E3 of verifying whether the noted temperature T_PCB of the carrier has reached a maximum temperature threshold Tm not to be passed beyond.

If this maximum temperature threshold Tm is not reached, a command to lower the setpoint is generated (step E4).

The method may then be reiterated by again noting the temperature T_PCB of the carrier in the following iteration and by comparing this temperature T_PCB with the first temperature threshold T1, and in particular with the various temperature thresholds Tn. If the noted temperature T_PCB is lower than the first temperature threshold T1, the method returns to the preceding setpoint command.

If and as long as the noted temperature T_PCB of the carrier is at or beyond a temperature threshold Tn of rank n, i.e. if and as long as the noted temperature T_PCB is higher than or equal to the temperature threshold Tn of rank n, T1 or T2 for example, while being lower than the temperature threshold Tn+1 of higher rank n+1, T2 or T3 for example, respectively, for n varying from one to m−1, the higher the rank n of the temperature threshold Tn, the more the setpoint is lowered.

Until the maximum temperature threshold Tm is reached, each time the noted temperature T_PCB of the carrier reaches or even passes beyond a higher temperature threshold Tn+1, the setpoint is lowered by a larger amount.

Until the maximum temperature threshold Tm is reached, for each temperature threshold Tn reached, the setpoint may be lowered by a predetermined increment. Thus, the setpoint is lowered in steps. The increment may be constant between the various temperature thresholds. Alternatively, between various temperature thresholds Tn, the increment by which the setpoint is lowered may vary.

For safety's sake, if the noted temperature T_PCB of the carrier reaches, or even passes beyond, the maximum temperature threshold Tm, a command to stop the electrical supply of the resistive elements may be generated (step E5).

In order to illustrate an example of implementation of the method, a graph of variation in the temperature T_PCB of the carrier as a function of a setpoint and with various temperature thresholds T1 to T5 has been schematically shown in FIG. 2a. This graph has been plotted for a power setpoint in percent of a maximum permitted power setpoint P_(sub)system_target_0; however, this example may be applied to other setpoints.

Thus, with reference to FIGS. 1 and 2a, the temperature T_PCB of the carrier is noted, in step E1, and is subsequently compared, in step E2, with the temperature thresholds T1 to T5. The first temperature threshold T1 is for example about 95° C. This first temperature threshold T1 is lower than the maximum temperature threshold Tm, which corresponds to T5 in the example of FIG. 2a, and for example to about 120° C. The first temperature threshold T1 is placed sufficiently far from the maximum temperature threshold Tm to allow the system to anticipate overheating and apply cooling before the maximum temperature threshold Tm is reached.

If the noted temperature T_PCB of the carrier is lower than the first temperature threshold T1, the setpoint is not lowered and the temperature T_PCB of the carrier remains monitored (steps E1-E2).

As soon as the noted temperature T_PCB of the carrier reaches or passes beyond one of the temperature thresholds T1 to T4, i.e. it becomes higher than or equal to this temperature threshold T1, T2, T3, T4, a command to lower the setpoint will possibly be generated in step E4.

If the first temperature threshold T1 has been reached, the setpoint, the power setpoint in this example, then changes from P0 to P1 (P1<P0), i.e. by the predetermined increment, in step E4. The increment may for example be a percentage, for example between 5% and 30%, and in particular 20%, of the setpoint or of the value of the maximum permitted setpoint P_(sub)system_target_0.

Subsequently to the step E4 of commanding the setpoint to be lowered, the change in the temperature T_PCB of the carrier remains monitored and the method is reiterated.

In the second iteration, the temperature T_PCB of the carrier is again noted, in step E1, and compared with the first temperature threshold T1, and with the other temperature thresholds T2 to T5, in step E2.

If the noted temperature T_PCB of the carrier is lower than the predefined first temperature threshold T1, the method returns to the preceding setpoint command.

Conversely, if and as long as the temperature T_PCB of the carrier is higher than or equal to the first predefined temperature threshold T1 and lower than the second predefined temperature threshold T2, the preceding command to lower the setpoint, in this example to P1, is maintained. The setpoint, which was lowered in the preceding iteration, is not limited, i.e. lowered, again.

If the second predefined temperature threshold T2 is reached, the second threshold T2 being higher than the first temperature threshold T1 and lower than the maximum threshold Tm, i.e. if the noted temperature T_PCB of the carrier is higher than or equal to the second temperature threshold T2, then a command to lower the setpoint more, i.e. more than in the case where only the first threshold T1 is exceeded, may be generated, in step E4, so as to accentuate the lowering of the setpoint, of the power setpoint in this example, which passes to P2 (P2<P1).

Subsequently to the step E4 of commanding the setpoint to be lowered, the change in the temperature T_PCB of the carrier remains monitored and the method is reiterated, as explained above. The temperature T_PCB of the carrier is again noted in step E1 and compared with the temperature thresholds Tn.

If the third temperature threshold T3 is reached by the temperature T_PCB of the carrier, then a command to lower the setpoint more, i.e. more than in the case where the preceding thresholds T1 and T2 are exceeded, is generated, in step E4, so as to further accentuate the lowering of the setpoint, of the power setpoint in this example, which passes to P3 (P3<P2). And so on: if the temperature T_PCB of the carrier reaches a predefined fourth temperature threshold T4, in step E2, higher than the third temperature threshold T3 and lower in this example than the maximum temperature threshold T5, the lowering of the setpoint is accentuated still further, and the setpoint, the power setpoint in this example, passes to P4 (P4<P3).

If the temperature T_PCB of the carrier reaches or even passes beyond the maximum threshold, which corresponds to T5 in the example of FIG. 2a, the setpoint is not limited anew but rather a command to stop supplying the resistive elements is generated in step E5.

In the example of FIG. 2a, the setpoint is lowered in constant predetermined increments between P0, P1, P2, P3, P4, on reception of associated commands to lower.

Alternatively, as schematically shown in FIG. 2b, the setpoint, in this example the power setpoint, may be lowered between P0, P1, P2, P3, P4 in different predetermined increments. The increment between the various thresholds Tn, in this example the thresholds T1 to T5, may therefore vary. The variable increment may for example be computed by means of an algorithm stored in a command of the electrical heating device. For example, depending on test results, it may be chosen to have a large increment at the start (for example between P0 and P1) then subsequent increments that are increasingly small. The increment between P4 and P3 is smaller than the increment between P3 and P2, which increment itself is smaller than that between P2 and P1, which is smaller than the increment between P1 and P0. The converse is also envisionable, the increment becoming increasingly large with the increase in the temperature threshold reached or passed beyond.

FIG. 2b shows yet another example of a variable increment, the increment being larger at the start and increasingly small. With different temperature thresholds, for example, the maximum temperature threshold Tm may be set to the fourth temperature threshold T4.

Referring again to FIG. 1, after the electrical supply of the resistive elements has been stopped in step E5, the method may comprise at least one step (step E6) of verifying a condition permitting resumption of the electrical supply.

A first verifying step may comprise the following sub-steps: noting the temperature T_PCB of the carrier with the maximum temperature threshold Tm after having stopped the electrical supply, and verifying whether the noted temperature T_PCB of said carrier noted is lower than the maximum temperature threshold Tm.

By way of example, an additional verification may comprise sub-steps of noting the temperature T_PCB of the carrier after stoppage, and comparing it with a predefined resumption temperature threshold T0. Resumption of the electrical supply of the resistive elements is permitted when the noted temperature T_PCB of the carrier is lower than the predefined resumption temperature threshold T0, and a command to resume the electrical supply of the resistive elements is generated in step E7.

The predefined resumption threshold T0 may take any value comprised between a value lower than or equal to the first threshold T1 for example and the maximum temperature threshold Tm. By way of illustrative example, the resumption threshold T0 is for example set to the first temperature threshold T1 (T0=T1). Alternatively, the resumption threshold T0 may correspond to the first threshold from which a certain temperature, 10° C. for example, has been subtracted: T0=T1−10, or, alternatively, to the maximum temperature threshold Tm from which a certain temperature, 10° C. for example, has been subtracted: T0=Tm−10.

After it has been cut, the electrical supply of the resistive elements may restart with a limited setpoint or at the maximum permitted setpoint value.

The thermal management method described above with reference to FIGS. 1 to 2c makes it possible, simply, to detect any overheating and to protect the carrier of the electrical supply circuit and consequently the heating device, by providing a margin between the first temperature threshold T1 and the maximum temperature threshold Tm in which to act and allow the heating device to cool, before a critical temperature is reached.

Thermal Management Strategy

With reference to FIG. 3, the operation of the electrical heating device according to a thermal management strategy will now be described, this strategy comprising one or more of the control phases described below. The control phases are advantageously implemented in the specified order.

In operation, in particular in a motor vehicle, a user may use a control to activate the electrical heating device, which comprises, as described above, one or more subsets of resistive elements, for example in order to heat at least one zone of the passenger compartment of the motor vehicle. This activation results, in the control unit, in generation of a request for a setpoint, a power setpoint_P_(sub)system_target_0 for example.

First Phase

In a first phase, the setpoint, the power setpoint_P_(sub)system_target_0 for example, requested by a user of the heating device, via his heating control, may or may not be limited by applying a first filter F1. This first filter F1 consists in determining, depending on at least one operating parameter of the electrical heating device, a maximum allowable setpoint P_max_allowed. If the requested setpoint_P_(sub)system_target_0 is higher than the maximum allowable setpoint P max_allowed, the setpoint is limited to the latter.

The operating parameter may be chosen from an entry temperature of an air flow (which for example is a temperature datum delivered by a measurement sensor), an air flow rate, a speed of a fan or air blower, information on the position of at least one flap in a flow duct of the air flow, upstream or downstream of the heating device in the direction of flow of the air flow, or even whether a mode of heating the air flow by an element upstream of at least one subset of elements in the direction of flow of the air flow is activated or not.

Such a limitation is known to those skilled in the art of electrical heating devices for motor-vehicle heating and/or ventilation and/or air-conditioning apparatuses employing air flow and is not detailed below.

If the setpoint, the power setpoint for example, is limited by the first filter F1, the setpoint P_(sub)system_target_1 at the end of the first phase is equal to the determined maximum allowable setpoint P_max_allowed (arrow Y).

In the contrary case (arrow N), the setpoint P_(sub)system_target_1 at the end of the first phase remains the requested initial setpoint, the requested initial power setpoint P_(sub)system_target_0 for example.

Second Phase

After it has been determined whether or not to apply the first filter F1 to limit the setpoint a first time, a second control phase is implemented. In this second phase, the setpoint P_(sub)system_target_1 at the end of the first phase may be regulated depending on the temperature of the carrier of the electrical supply circuit of the resistive elements and on any temperature thresholds reached or passed beyond, in accordance with the thermal management method described above with reference to FIGS. 1 to 2c.

The second filter F2 may potentially be applied to the requested initial setpoint P_(sub)system_target_0 if the filter 1 was not applied to the latter at the end of the first control phase, or, alternatively, the filter 2 may be applied to the maximum allowable setpoint P_max_allowed determined in the first phase.

If the setpoint, the power setpoint for example, is limited by the second filter F2 (arrow Y), the setpoint P_(sub)system_target_2 at the end of the second phase is equal to the setpoint P_(sub)system_target_1 at the end of the first phase lowered by a certain predetermined factor or increment as described above, depending on the temperature thresholds reached or passed beyond by the temperature of the carrier of the electrical supply circuit.

In the contrary case (arrow N), the setpoint, the power setpoint P_(sub)system_target_2 for example, at the end of the second phase remains the setpoint, the power setpoint P_(sub)system_target_1 for example, at the end of the first phase.

Third Phase

After having determined whether the second filter F2 is applied or not to limit the setpoint, a third control phase is implemented. In this third phase, the setpoint P_(sub)system_target_2 at the end of the second phase may be limited gradually in predefined increments.

The third filter F3 may be applied to the initial setpoint P_(sub)system_target_2 at the end of the second phase. It may be a question of the requested initial setpoint P_(sub)system_target_0 if no filter has been applied, of the maximum allowable setpoint P_max_allowed if the first filter F1 was applied, or of the setpoint P_(sub)system_target_1 at the end of the first phase lowered by a certain predetermined factor or increment depending on the temperature of the carrier of the electrical supply circuit if the second filter F2 was applied.

In this third phase, generally, the setpoint may be gradually regulated in one direction, such as to be limited, i.e. lowered, then in the other direction, such as to be increased, depending on the variation in a given parameter with respect to a variable threshold tailored to each setpoint regulation.

According to one option, the setpoint is preferably an electrical power setpoint P_(sub)system_target_2, and the heating device is controlled in a closed-loop mode. As a variant, the resistive elements may be supplied electrically depending on a temperature setpoint. It is possible to envisage an alternative with a constant-voltage electrical current setpoint, or potentially a resistance setpoint.

With reference to FIG. 4a, overheating of the heating device may be detected by noting, in step E30, the duty cycle PWM_(sub)system of the control signal of at least one subset of resistive elements forming a subsystem and by monitoring its variation so as to detect when the duty cycle PWM_(sub)system of the control signal passes beyond a corresponding detection threshold value PWM_(sub)system_lim_i (step E31), representative of overheating.

If and as long as the duty cycle PWM_(sub)system of the control signal is beyond the detection threshold value PWM_(sub)system_lim_i, overheating is detected. For example, for resistive elements of positive temperature coefficient, overheating is detected when the duty cycle PWM_(sub)system of the control signal is higher, and more precisely strictly higher, than the detection threshold value PWM_(sub)system_lim_i.

The setpoint is regulated gradually in one direction, in a first regulating phase A, such as to be reduced. This limitation is reiterated until the duty cycle of the control signal is no longer representative of overheating. In this case, the setpoint may be regulated in a second regulating phase B, in a direction of change opposite to the direction of the first phase A, such as this time to be increased. This regulation is advantageously also gradual, until the starting setpoint is reached. Either or both of the regulating phases A, B is advantageously iterated or reiterated with a predefined period, which may be less than 10 s, and for example of the order of 4 s. This leaves the heating device time to react without being too slow. Alternatively, the period may be variable. The period may depend for example on a degree of overheating.

The detection threshold value is valid for the subsystem or for the entire system. On each setpoint regulation, whether such as to limit or increase, a new threshold value is determined depending on the new setpoint value. In particular, the detection threshold value PWM_(sub)system_lim_i may be defined depending on the pair consisting of the supply voltage and of the setpoint, a matrix of possible detection threshold values then being obtained. In each iteration i, the detection threshold value PWM_(sub)system_lim_i of the duty cycle of the control signal is redetermined depending on the new value of the setpoint.

If the limited value of the setpoint reaches a predefined limit setpoint value, the first phase A is not reiterated and a command to stop the electrical supply of the resistive elements is generated in step E32.

With reference to FIG. 4b, according to another option, at least one parameter i_(sub)system_max, R_(sub)system, P_(sub)system, T_(sub)system for monitoring overheating is noted. Overheating is detected if this parameter reaches or passes beyond a corresponding detection threshold value i_(sub)system_max_lim_i, R_(sub)system_lim_i, P_(sub)system_lim_i, T_(sub)system_lim_i, taking into account the supply setpoint.

As before, the setpoint is preferably an electrical power setpoint P_(sub)system_target_2, and the heating device is controlled in a closed-loop mode. As a variant, the resistive elements may be supplied electrically depending on a temperature setpoint. It is possible to envisage an alternative with a constant-voltage electrical current setpoint, or potentially a resistance setpoint.

The parameter is advantageously dependent on the electrical current amplitude, with a view to monitoring overheating of the electrical heating device. It may be a question of the electrical resistance R_(sub)system of the predefined number of resistive elements, of the electrical power P_(sub)system of the predefined number of resistive elements, or of the electrical current i_(sub)system_max flowing through the predefined number of resistive elements. The parameter may also be a multiple or a power of the electrical current flowing through the predefined number of resistive elements. Mention may be made, non-exhaustively, of the square or cube of the electrical current, of two times the electrical current or even of the ratio of the electrical current to the duty cycle of the pulse-width modulated control signal.

Alternatively, the parameter may not be dependent on the amplitude of the electrical current. Mention may be made, for example, of the temperature T_(sub)system of the predefined number of resistive elements.

The “sub” prefix has been written between parentheses to indicate that a parameter regards either a subset of resistive elements or all of the resistive elements.

Overheating of the heating device may be detected by noting, in step E33, the chosen parameter and by monitoring its variation so as to detect when it reaches or passes beyond a corresponding detection threshold value i_(sub)system_max_lim_i, R_(sub)system_lim_i, P_(sub)system_lim_i, T_(sub)system_lim_i (step E34), representative of overheating.

The noted value of the parameter may pass beyond the detection threshold value, such as to become higher or lower than it, depending on the nature of this parameter and on the nature of the resistive elements. For example, in the case of PTC resistive elements, if the recorded value of the electrical current i_(sub)system_max flowing through the resistive elements is lower, and more precisely strictly lower, than the detection threshold value i_(sub)system_max_lim_i, overheating is detected.

According to another example, in the case of PTC resistive elements, if the computed value of the electrical resistance R_(sub)system of the resistive elements is higher, and more precisely strictly higher, than the detection threshold value R_(sub)system_lim_i, overheating is detected.

If and as long as the chosen parameter i_(sub)system_max, R_(sub)system, P_(sub)system, T_(sub)system is at or has passed beyond the detection threshold value i_(sub)system_max lim_i, R_(sub)system_lim_i, P_(sub)system_lim_i, T_(sub)system_lim_i, overheating is detected (arrow Y).

The setpoint is regulated gradually in one direction, in a first regulating phase A, such as to be reduced. This limitation is reiterated until the chosen parameter i_(sub)system_max, R_(sub)system, P_(sub)system, T_(sub)system is no longer representative of overheating. In this case, the setpoint may be regulated in a second regulating phase B, in a direction of change opposite to the direction of the first phase A. This regulation is advantageously also gradual, until the starting setpoint is reached. Either or both of the regulating phases A, B is advantageously iterated or reiterated with a predefined period, which may be less than 10 s, and for example of the order of 4 s, and which may be constant or variable.

On each setpoint regulation, whether such as to limit or increase, a new threshold value is determined depending on the new setpoint value. In particular, the detection threshold value i_(sub)system_max_lim_i, R_(sub)system_lim_i, P_(sub)system_lim_i, T_(sub)system_lim_i may be defined depending on the pair consisting of the supply voltage and of the setpoint, a matrix of possible detection threshold values then being obtained. In each iteration i, the detection threshold value of the parameter i_(sub)system_max_lim_i, R_(sub)system_lim_i, P_(sub)system_lim_i, T_(sub)system_lim_i is redetermined depending on the new value of the setpoint.

If the limited value of the setpoint reaches a predefined limit setpoint value, the first phase A is not reiterated and a command to stop the electrical supply of the resistive elements is generated in step E35.

According to yet another option, the supply setpoint is a setpoint of the duty cycle of the control signal, which setpoint is referred to as the PWM setpoint below. This PWM setpoint PWM_(sub)system_target_i is regulated gradually, in each iteration i, in predefined increments, if and as long as at least one parameter P_(sub)system; R_(sub)system; i_(sub)system_max for monitoring overheating, said parameter being dependent on electrical current, exceeds a corresponding detection threshold value P_(sub)system_lim_i; i_(sub)system_max_lim_i; R_(sub)system_lim_i.

Overheating of the heating device may be detected by noting, in step E36, the chosen parameter and by monitoring its variation so as to detect when it passes beyond a corresponding detection threshold value i_(sub)system_max_lim_i, R_(sub)system_lim_i, P_(sub)system_lim_i (step E37), representative of overheating.

The noted value of the parameter may pass beyond the detection threshold value, such as to become higher or lower than it, depending on the nature of this parameter and on the nature of the resistive elements.

The PWM setpoint is regulated gradually in one direction, in a first regulating phase A, such as to be reduced. This limitation is reiterated until the chosen parameter i_(sub)system_max, R_(sub)system, P_(sub)system is no longer representative of overheating. In this case, the PWM setpoint may be regulated in a second regulating phase B, in a direction of change opposite to the direction of the first phase A. This regulation is advantageously also gradual, until the starting setpoint is reached. Either or both of the regulating phases A, B is advantageously iterated or reiterated with a predefined period, which may be less than 10 s, and for example of the order of 4 s, and which may be constant or variable.

On each regulation of the PWM setpoint, whether such as to limit or increase, a new threshold value is determined depending on the new value of the setpoint PWM_(sub)system_target_i. In particular, the detection threshold value i_(sub)system_max_lim_i, R_(sub)system_lim_i, P_(sub)system_lim_i may be defined depending on the pair consisting of the supply voltage and of the PWM setpoint, a matrix of possible detection threshold values then being obtained. In each iteration i, the detection threshold value i_(sub)system_max_lim_i, R_(sub)system_lim_i, P_(sub)system_lim_i of the parameter is redetermined depending on the new value of the PWM setpoint PWM_(sub)system_target_i.

If the limited value of the setpoint PWM_(sub)system_target_i reaches a predefined limit setpoint value, the first phase A is not reiterated and a command to stop the electrical supply of the resistive elements is generated in step E38.

It is possible to apply the third control phase to all the resistive elements together, or independently to each subset of resistive elements, each subset being controlled using one transistor or a plurality of transistors. The strategy also varies depending on the nature of the resistive elements and for example depending on whether they are resistive elements of positive temperature coefficient (PTC) or negative temperature coefficient (NTC).

Referring again to FIG. 3, if the setpoint, the power setpoint for example, is limited by the third filter F3 (arrow Y), the setpoint P_(sub)system_target_3 at the end of the third phase is equal to the setpoint P_(sub)system_target_2 at the end of the second phase but regulated according to one of the options of the third phase described above.

In the contrary case (arrow N), the setpoint, the power setpoint P_(sub)system_target_3 for example, at the end of the third phase remains the setpoint, the power setpoint P_(sub)system_target_2 for example, at the end of the second phase.

Fourth Phase

If, on applying the third filter F3, the regulated value of the setpoint has not reached the limit setpoint value, a fourth control phase may be implemented.

In this fourth phase, the electrical resistance of at least one subset of resistive elements may be determined and compared with a predefined threshold value. The electrical resistance is computed on the basis of preliminary measurements of supply voltage and of electrical current.

If the electrical resistance reaches this threshold value (arrow Y), a fourth filter F4 is applied, whereon a command to stop the electrical supply of the resistive elements for a predetermined time is generated. The setpoint, the power setpoint for example, after application of the fourth filter F4 (arrow Y) is lowered to 0%.

In the contrary case (arrow N), the setpoint, the power setpoint P_(sub)system_target_3 for example, at the end of the fourth phase remains the setpoint, the power setpoint P_(sub)system_target_3 for example, at the end of the third phase.

Fifth Phase

If the fourth filter F4 for cutting the electrical supply is not applied, a fifth control phase may be implemented.

In this fifth phase, referring again to FIGS. 1 to 2c, the temperature T_PCB of the carrier of the electrical supply circuit of the resistive elements is noted and monitored. The maximum temperature threshold T_max is higher than the temperature thresholds Tn, n varying from 1 to m−1, of the second phase (see FIGS. 1 to 2c).

If the noted carrier temperature T_PCB reaches a maximum temperature threshold Tm, a fifth filter F5 may be applied. The fifth filter F5 consists in generating a command to stop the electrical supply of the resistive elements for a predetermined time. The setpoint, the power setpoint for example, after application of the fifth filter F5 (arrow Y) is lowered to 0%.

In the contrary case (arrow N), the setpoint, the power setpoint P_(sub)system_target_5 for example, at the end of the fifth phase remains the setpoint, the power setpoint P_(sub)system_target_3 for example, at the end of the third phase.

The conditions of application of the control phases are verified successively from the first to the fifth phase in that order.

If, on applying the third filter F3, the regulated value of the setpoint has reached the limit setpoint value, or if, on applying the fourth filter F4 or fifth filter F5, the electrical supply of the resistive elements has been cut, the predetermined stoppage time is for example of the order of 130 s.

After the electrical supply to the resistive elements has been cut, the method may comprise a step of generating a command to resume the electrical supply of the resistive elements.

The command to resume electrical supply may be generated at the end of the predefined stoppage time. The strategy may start again from the beginning, the temperature of the carrier of the electrical supply circuit again being monitored. After this stoppage, the setpoint may be set to 100% or alternatively it may be limited for example to 55% of the maximum permitted setpoint.

By regulating the setpoint according to the thermal strategy, i.e. by successively applying one or more of the filters F1-F5, from the first to the fifth, in that order, it is possible for the system to act and detect, on each incrementation, a condition that might not have been detected in the preceding phase, and thus to ensure an effective temperature control.

Control Unit

The thermal management method such as described above with reference to FIGS. 1 to 2c may be implemented by a control unit (not shown in the figures). It is a question of an electronic control unit. In particular, the thermal management method may be implemented by the control unit already used to control the heating modules of the electrical heating device and/or to detect overheating.

The control unit comprises at least one processing means for implementing the steps of the thermal management method.

The control unit may comprise at least one processing means for noting the temperature T_PCB of the carrier of the electrical supply circuit of the resistive elements. It may for example be a question of a temperature sensor, such as a thermal probe of negative temperature coefficient.

The control unit may comprise a comparator for comparing the noted temperature T_PCB of the carrier with predefined temperature thresholds Tn or with a resumption threshold T0 following a stoppage of the electrical supply of the resistive elements.

The control unit comprises one or more processing means for noting the power setpoint, or temperature setpoint, or electrical current setpoint, or even resistance setpoint.

The control unit may comprise a computing means or microprocessor for determining, depending on the results of the comparisons, whether the setpoint must be regulated and for regulating the setpoint depending on the temperature thresholds reached.

The control unit may comprise another or the same computing means or microprocessor for generating a command to stop the electrical supply of the resistive elements for a predefined stoppage time, when a regulated setpoint value reaches the limit setpoint value defined for the first regulating phase A.

Lastly, generally, the control unit may comprise one or more processing means such as measuring or computing means or a microprocessor for monitoring the variation in one or more parameters, with a view to verifying, in the order of the control phases, whether a condition of application of one or other of the filters F1 to F5 has been met, and to applying one or other of the filters F1 to F5 so as to regulate the setpoint as described above.

1. A thermal management method for an electrical heating device comprising at least one subset of resistive elements configured to be supplied electrically and a carrier of an electrical supply circuit of the resistive elements, wherein the electrical supply of the resistive elements is controlled depending on a power setpoint or a temperature setpoint or an electrical current setpoint or a resistance setpoint, or even depending on a setpoint of the duty cycle of the control signal, characterized in that the said method comprises:
observing the temperature of the carrier of the electrical supply circuit of the resistive elements;
comparing the observed temperature with at least one predefined temperature threshold; and
if the noted observed temperature is higher than or equal to said at least one predefined temperature threshold, generating a command to lower said setpoint by a predetermined increment.

2. The method as claimed in claim 1, wherein a predetermined number of temperature thresholds is defined, the temperature thresholds being of rank n and varying from one to a predefined maximum number m, said method further comprising:
the observed temperature of said carrier is compared with the temperature thresholds of rank n; and
if the observed temperature is higher than or equal to the temperature threshold of given rank n and lower than the temperature threshold of higher rank n+1, for n varying from one to m−1, the higher the rank n of the temperature threshold the more the lowering of said setpoint is accentuated.

3. The method as claimed in claim 2, wherein, after a temperature threshold of rank n has been passed beyond, and following an associated command to lower, said method comprises:
observing and again comparing the temperature of said carrier with the temperature threshold of rank n and with a temperature threshold of higher rank n+1,
if and as long as the observed temperature is higher than or equal to the temperature threshold of rank n and lower than the temperature threshold of higher rank n+1, maintaining said lowered setpoint as set by the preceding command to lower,
if the observed temperature is lower than the temperature threshold of rank n, returning to the preceding command to lower said setpoint,
if the observed temperature is higher than or equal to the temperature threshold of higher rank n+1, generating a command to lower said setpoint more so as to accentuate the lowering.

4. The method as claimed in claim 1, wherein a maximum temperature threshold higher than said at least one temperature threshold is defined, said method comprises comparing the noted observed temperature with the maximum temperature threshold, and, if the maximum temperature threshold has been reached, said method comprises of generating a command to stop the electrical supply of said at least one subset of resistive elements.

5. The method as claimed in claim 4, wherein after the electrical supply of said at least one subset of resistive elements has been stopped, said method comprises verifying a condition permitting resumption of the electrical supply.

6. The method as claimed in claim 5, wherein a first verifying step comprises:
after the electrical supply has been stopped, observing the temperature of said carrier with the maximum temperature threshold, and
verifying whether the observed temperature of said carrier is lower than the maximum temperature threshold.

7. The method as claimed in claim 6, wherein an additional verifying comprises:
observing the temperature of the carrier of the electrical supply circuit of the resistive elements and comparing it with a predefined resumption temperature threshold, and
if the noted temperature is lower than the predefined resumption temperature threshold, generating a command to resume the electrical supply of said at least one subset of resistive elements.

8. The method as claimed in claim 7, wherein the predefined resumption threshold is lower than or equal to said at least one threshold and/or lower than the maximum threshold.

9.-10. (canceled)

11. A control unit for an electrical heating device comprising:
at least one subset of resistive elements configured to be supplied electrically and a carrier of an electrical supply circuit of the resistive elements,
the control unit being configured to generate a control signal depending on a power setpoint, or a temperature setpoint, or an electric current setpoint, or a resistance setpoint, or even a setpoint of the duty cycle of the control signal; and
at least one processing means for:
observing the temperature of the carrier of the electrical supply circuit of the resistive elements,
comparing the noted temperature with at least one predefined temperature threshold, and
if the noted temperature is higher than or equal to said at least one predefined temperature threshold, generating a command to lower said setpoint by a predetermined increment.

12. The control unit as claimed in claim 11, wherein the resistive elements are of positive temperature coefficient.

13. The control unit as claimed in claim 11, comprising one or more processing means for implementing, at least in part, at least one control phase of a thermal management strategy.
